(19) United States
(12) Patent Application Publication
(10) Pub. No.: US 2012/0014144 A1
(43) Pub. Date: Jan. 19, 2012

(54) POWER SUPPLYING APPARATUS

(76) Inventors: Ming Xu, Nanjing (CN); Chuan-Yun Wang, Nanjing (CN); Chih-Chung Chen, Taoyuan County (TW)

(21) Appl. No.: 13/006,428

(22) Filed: Jan. 14, 2011

Related U.S. Application Data
(60) Provisional application No. 61/295,178, filed on Jan. 15, 2010.

(30) Foreign Application Priority Data
Jun. 2, 2010 (TW) 99117748

(51) Int. Cl. H02M 1/44

(52) U.S. Cl. 363/48

(57) ABSTRACT

A power supplying apparatus includes a rectifier and a first electromagnetic interference (EMI) filter. The rectifier receives and rectifies an alternating current (AC) input power for generating a direct current (DC) power. The first EMI filter receives the DC power through a first power input terminal and a first reference input terminal thereof. The first EMI filter filters the DC power for generating a DC output power between a first power output terminal and a first reference output terminal thereof. The first EMI filter includes an inductor module, a first X capacitor, and a first Y capacitor.

### CROSS-REFERENCE TO RELATED APPLICATION

This application claims the priority benefit of U.S. provisional application Ser. No. 61/295,178, filed on Jan. 15, 2010 and Taiwan application serial no. 99117748, filed Jun. 2, 2010. The entirety of each of the above-mentioned patent applications is hereby incorporated by reference herein and made a part of specification.

### BACKGROUND OF THE INVENTION

1. Field of the Invention

The present invention relates to a structure of a power supplying apparatus, and more particularly, to a configuration of a filter of a switch type power supplying apparatus.

2. Description of Related Art

Conductive electromagnetic interference (EMI) is transferred through a power cable of a power supplying apparatus connected to a same electrical system. Currently, it is very common that an EMI filter is installed to prevent the conductive EMI.

FIG. 1 illustrates a configuration of an EMI filter of a conventional power supplying apparatus. Referring to FIG. 1, in the power supplying apparatus 100, the EMI filter 111 receives and filters a single-phase alternating current (AC) input power VIN to produce a filtered AC input power FVIN. A rectifier 112 is coupled to the EMI filter 111 to receive the filtered AC input power FVIN. The rectifier 112 rectifies the filtered input power FVIN to produce a direct current (DC) output power VOUT. The power supplying apparatus 120 receives a three-phase AC input power VINA, VINB and VINC. An EMI filter 121 and a rectifier 122 are used to perform filtering and rectification, respectively, to produce a DC output power VOUT. In other words, each of the EMI filters 111, 121 of the convention power supplying apparatus 110, 120 directly receives the AC input power VIN or VINA to VINC.

It is noted that, under such conventional configuration architecture of the EMI filter, the EMI filters 111, 121 are directly connected to the AC input power VIN and VINA to VINC, respectively. Therefore, the circuit layout of the EMI filters 111, 121 must comply with the safety specifications regarding the distance between fire and neutral lines. In addition, capacitors used in the EMI filters 111, 121 are directly connected to the AC input network. Therefore, in order to comply with the safety specifications, the capacitors must be safety specification capacitors. However, the safety specification capacitors generally have larger size than that of ordinary capacitors, are more expensive than ordinary capacitors, and have relatively smaller capacitance. Furthermore, the EMI filters 111, 121 must also include some safety specification resistors connected in parallel with the safety specification capacitors to provide discharge paths for the safety specification capacitors. These resistors consume a certain ratio of power in the power supplying apparatus 110, 120, and the ratio of the power consumed by the resistors is considerably high at zero-load of the power supplying apparatus 110, 120.

### SUMMARY OF THE INVENTION

Accordingly, the present invention is directed to three power supplying apparatus which can effectively reduce the price, size and number of the filter inductors, capacitors and resistors used in the EMI filter, thus effectively reducing the circuit cost.

The present invention provides a power supplying apparatus including a rectifier and a first electromagnetic filter. The rectifier receives and rectifies an alternating current input power to produce a direct current power. The first electromagnetic interference filter directly receives the direct current power through a first power input terminal and a first reference input terminal, and filters the direct current power to produce a direct current output power between a first power output terminal and a first reference output terminal. The first electromagnetic interference filter includes a first inductor module, a first X capacitor, and a first Y capacitor. The first inductor module is bridged between the first power input terminal, the first reference input terminal, the first power output terminal and the first reference output terminal. The first X capacitor is bridged between the first power input terminal and the first reference input terminal. One terminal of the first Y capacitor is coupled to one of the first power input terminal, the first power output terminal, the first reference input terminal and the first reference output terminal, and the other terminal of the first Y capacitor is coupled to a ground terminal.

According to one embodiment of the present invention, the first inductor module is a common mode inductor or a differential mode inductor.

According to one embodiment of the present invention, the first electromagnetic interference filter further includes a second, a third and a fourth Y capacitors. The second, third and fourth Y capacitors are commonly connected to the ground terminal, and are coupled to three of the first power input terminal, the first power output terminal, the first reference input terminal and the first reference output terminal that are not coupled to the first Y capacitor.

According to one embodiment of the present invention, the power supplying apparatus further includes a second electromagnetic interference filter connected between the rectifier and the first electromagnetic interference filter. The second electromagnetic interference filter has a second power input terminal, a second reference input terminal, a second power output terminal and a second reference output terminal. The second power input terminal and the second reference input terminal are coupled to the rectifier, the second power output terminal is coupled to the first power input terminal, and the second reference output terminal is coupled to the first reference input terminal.

According to one embodiment of the present invention, the second electromagnetic filter includes a second inductor module, a second X capacitor and a fifth Y capacitor. The second inductor module is bridged between the second power input terminal, the second reference input terminal, the second power output terminal and the second reference output terminal. The second X capacitor is bridged between the second power input terminal and the second reference input terminal. One terminal of the fifth Y capacitor is coupled to the second power input terminal, and the other terminal of the fifth Y capacitor is coupled to the ground terminal.

According to one embodiment of the present invention, the second electromagnetic interference filter further includes a sixth Y capacitor. One terminal of the sixth Y capacitor is coupled to the second reference input terminal, and the other terminal of the sixth Y capacitor is coupled to the ground terminal.

According to one embodiment of the present invention, the second electromagnetic interference filter further includes a first gas discharge tube and a second gas discharge tube. The first gas discharge tube is connected between the second power input terminal and the second power output terminal. The second gas discharge tube is connected between the second reference input terminal and the second reference output terminal.

According to one embodiment of the present invention, the second electromagnetic interference filter further comprises a first resistor and a second resistor. The first resistor has one terminal coupled to the second power input terminal. The second resistor has one terminal coupled to the other terminal of the first resistor, and the other terminal of the second resistor is coupled to the second reference input terminal.

According to one embodiment of the present invention, the first electromagnetic interference filter further comprises a first resistor and a second resistor. The first resistor has one terminal coupled to the first power input terminal. The second resistor has one terminal coupled to the other terminal of the first resistor, and the other terminal of the second resistor is coupled to the first reference input terminal.

According to one embodiment of the present invention, the first electromagnetic interference filter further comprises a first gas discharge tube and a second gas discharge tube. The first gas discharge tube is connected between the first power input terminal and the first power output terminal. The second gas discharge tube is connected between the first reference input terminal and the first reference output terminal.

According to one embodiment of the present invention, the power supplying apparatus further includes a surge absorber bridged between the first power input terminal and the first reference input terminal.

According to one embodiment of the present invention, the rectifier is a bridge type rectifier.

The present invention provides another power supplying apparatus including a first electromagnetic interference filter, a rectifier and a second electromagnetic interference filter. The first electromagnetic interference filter directly receives and filters an alternating current input power. The first electromagnetic interference filter comprises a first inductor module and a first Y capacitor. The first inductor module is bridged between the first power input terminal, the first reference input terminal, the first power output terminal and the first reference output terminal. One terminal of the first Y capacitor is coupled to the first power input terminal, and the other terminal of the first Y capacitor is coupled to a ground terminal. The rectifier is coupled to the first electromagnetic interference filter to receive and rectify the filtered alternating current power to produce a direct current power. The second electromagnetic interference filter has a second power input terminal, a second reference input terminal, a second power output terminal and a second reference output terminal. The second electromagnetic interference filter is coupled to the rectifier and directly receives and filters the direct current power to produce a direct current output power. The second electromagnetic interference filter comprises a second inductor module, a second Y capacitor, and a first X capacitor. The second inductor module is bridged between the second power input terminal, the second reference input terminal, the second power output terminal and the second reference output terminal. One terminal of the second Y capacitor is coupled to one of the second power input terminal, the second reference input terminal, the second power output terminal and the second reference output terminal, and the other terminal of the second Y capacitor is coupled to the ground terminal. One terminal of the first X capacitor is coupled to the second power input terminal and the other terminal of the first X capacitor is coupled to the second reference input terminal and the other terminal of the first X capacitor is coupled to the ground terminal.

In view of the foregoing, in the present invention, a part of or all of the electromagnetic interference filters are moved to the back end of rectifier to filter the direct current power generated by the rectifier in response to the alternating current input power. As such, the part of or all of the electromagnetic interference filters do not need to be connected to the alternating current power. Therefore, the size and cost of the circuit elements of the power supplying apparatus can be reduced by not using safety specification capacitors. In addition, because the part of or all of the electromagnetic interference filters do not need to be connected to the alternating current power, the length of the fire and neutral lines of the alternating current power can also be effectively reduced, thereby making the power supplying apparatus more cost-effective.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates a configuration of an EMI filter of a conventional power supplying apparatus.

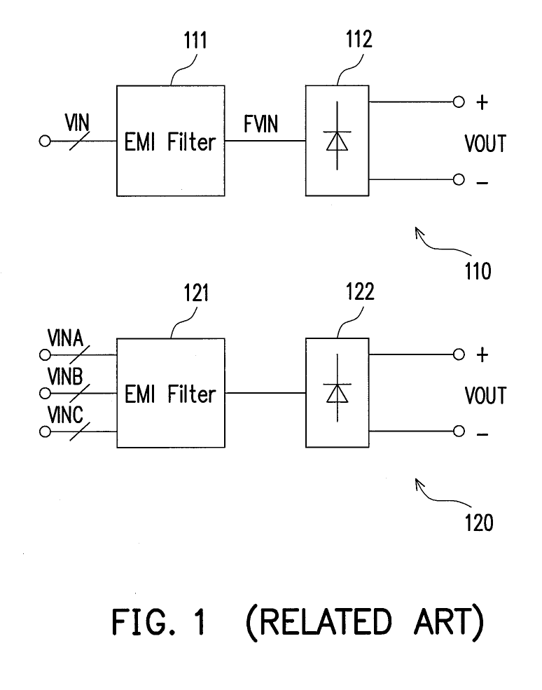

FIG. 2 illustrates a power supplying apparatus according to one embodiment of the present invention.

FIG. 3A illustrates a circuit of a power supplying apparatus according to another embodiment of the present invention.

FIG. 3B illustrates a circuit of the power supplying apparatus according to another embodiment.

FIG. 3C and FIG. 3D illustrate the EMI test results of the power supplying apparatus of FIG. 3A and FIG. 3B.

FIG. 4 illustrates a circuit of a power supplying apparatus according to another embodiment of the present invention.

FIG. 4A and FIG. 4B illustrate the EMI test results of the power supplying apparatus of FIG. 4.

FIG. 5 illustrates a circuit of a power supplying apparatus according to another embodiment of the present invention.

FIG. 5A and FIG. 5B illustrate the EMI test results of the power supplying apparatus of FIG. 5.

### DESCRIPTION OF THE EMBODIMENTS

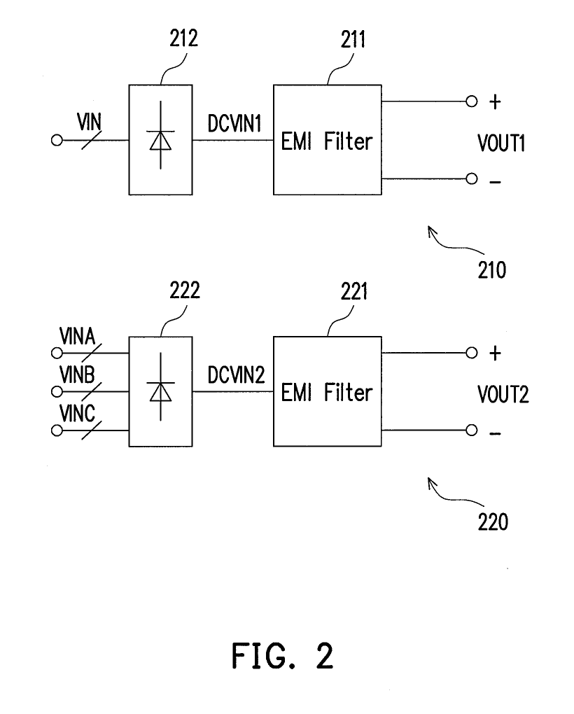

FIG. 2 illustrates a power supplying apparatus according to one embodiment of the present invention. Referring to FIG. 2, the power supplying apparatus 210 includes a rectifier 212 and an electromagnetic interference (EMI) filter 211. The rectifier 212 directly receives and rectifies an alternating current (AC) input power VIN to generate a direct current (DC) power DCVIN1. The EMI filter 211 is coupled to the rectifier 212 and receives the DC power DCVIN1 generated by the rectifier 212. The EMI filter 211 filters the DC power DCVIN1 to generate an output power VOUT1. The power supplying apparatus 220 includes a rectifier 222 and an EMI filter 221. The rectifier 222 directly receives three-phase AC input power VINA, VINB and VINC. The EMI filter 221 is coupled to the rectifier 222 to receive a DC power DCVIN2 generated by the rectifier 222. The EMI filter 221 filters the DC power DCVIN2 to generate an output power VOUT2.

As illustrated in FIG. 2, in either of the power supplying apparatus 210 and the power supplying apparatus 220, the power DCVIN1, DCVIN2 received by the EMI filter 211 or 221 is DC power. That is, the EMI filter 211 or 221 does not need to process an AC power. Rather, it processes a DC power with an AC component. Taking the power supplying apparatus 210 as an example, the voltage amplitude of the DC power DCVIN received by the EMI 211 is a half of the voltage amplitude of the AC input power VIN. Also because of this, the EMI filter 211 does not need to use those elements (e.g. resistors or capacitors) with capabilities to withstand very high voltage and current.

In addition, because the EMI filter 211 receives the DC power DCVIN, the AC component flowing through the capacitor of the EMI filter 211 is dramatically decreased. Also because of this, the capacitance of the EMI filter 211 can be increased accordingly and the safety specification capacitor in the conventional EMI filter 211 can be replaced with an ordinary capacitor not complying with safety specification. Because the capacitance is increased, inductance of the inductor module (may be reviewed as a common mode inductor or a differential mode inductor) in the EMI filer 211 can be decreased proportionally. In addition, the rectifier 212 has the characteristic of one-way conduction and, therefore, the resistor connected in parallel with the capacitor for providing a discharge path in the EMI filter 211 is no longer required. In summary, the cost of all elements for constructing the EMI filter 211 can be reduced thus effectively increasing the product competitiveness.

Regarding the circuit layout of the power supplying apparatus 210, 220, because the AC input power VIN and VINA to VINC no longer pass through the EMI filter 211, 221, the distance between the fire and neutral lines of the AC input power YIN and VINA to VINC can be significantly reduced. As such, the size of the circuit layout of the power supplying apparatus 210, 220 can be smaller and more compact while complying with the safety specification regarding the layout distance between the fire and neutral lines.

Below, the power supplying apparatus of the present invention is further explained by way of several exemplary embodiments, such that the present invention can be readily understood and carried out by those skilled in the art.

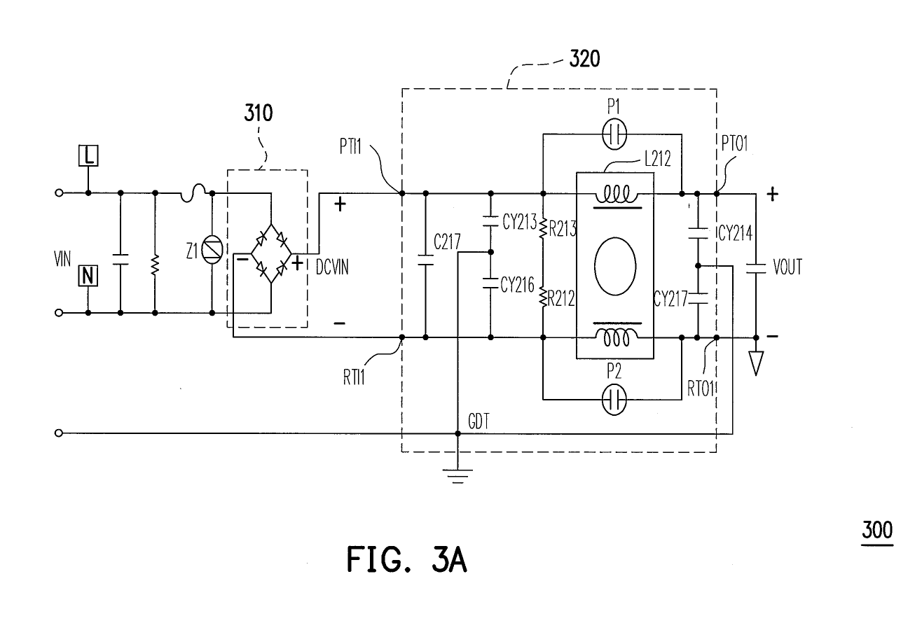

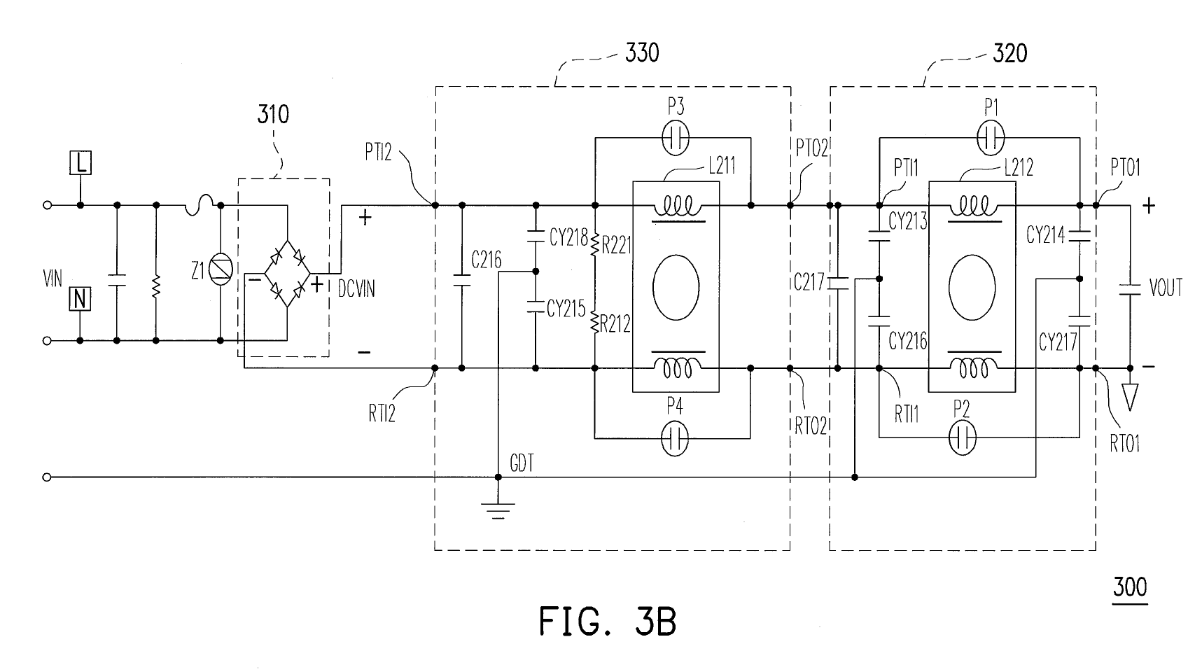

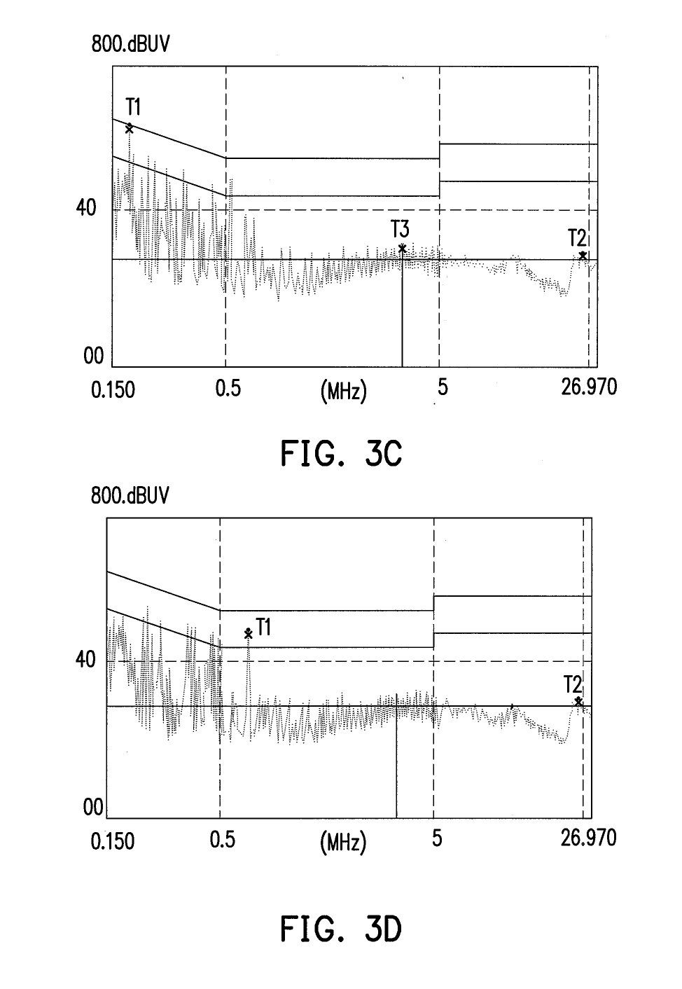

Referring first to FIG. 3A, FIG. 3A illustrates a circuit of a power supplying apparatus 300 according to another embodiment of the present invention. The power supplying apparatus 300 includes a rectifier 310 and an EMI filter 320. The rectifier 310 may be a bridge type rectifier which directly receives an AC input power VIN. The rectifier 310 filters the received input power VIN to generate a DC power DCVIN. The EMI filter 320 is connected to the rectifier 310 to receive and filter the DC power DCVIN to generate a DC output power VOUT.

The EMI filter 320 includes an X capacitor C217, Y capacitors CY213, CY216 and CY214 and CY217, resistors R212 and R213, and an inductor module L212. The EMI filter 320 includes a power input terminal PTI1, a reference input terminal RTI1, a power output terminal PTO1 and a reference output terminal RTO1. The X capacitor C217 is bridged between the power input terminal PTI1 and the reference input terminal RTI1. The Y capacitors CY213 and CY216 are connected in series between the power input terminal PTI1 and the reference input terminal RTI1, and the joint between the Y capacitors CY213 and CY216 is connected to a ground terminal GDT. The Y capacitors CY214 and CY217 are connected in series between the power output terminal PTO1 and the reference output terminal RTO1, and the joint between the Y capacitors CY214 and CY217 is connected to the ground terminal GDT. In addition, the resistors R213 and R212 are connected in series between the power input terminal PTI1 and the reference input terminal RTI1. Besides, the inductor module L212 is bridged between the power input terminal PTI1, the reference input terminal RTI1, the power output terminal PTO1, and the reference output terminal RTO1. A DC output power VOUT is thus produced between the power output terminal PTO1 and the reference output terminal RTO1. In the present embodiment, the inductor module L212 is implemented as a common mode inductor.

In the present embodiment, the EMI filter 320 receives and filters the DC power DCVIN. Therefore, the X capacitor C217 may be one with large capacitance, i.e. may be implemented as an ordinary capacitor not complying with the safety specifications. Besides, the resistors 8213 and R212 may be ones with large resistance, or are not needed to provide the discharge path for the X capacitor C217. As such, at zero-load of the power supplying apparatus 300, the power consumption of the leakage path resulted by the resistors R213 and R212 can be reduced or even eliminated. Furthermore, the inductor module L212 may be one with small inductance to reduce element cost.

It is noted that the power supplying apparatus 300 further includes a surge absorber Z1 bridged between two input terminals of the rectifier 310. With the function of absorbing surge, the surge absorber Z1 can protect the rectifier 310 and enhance the performance of the power supplying apparatus 300. In addition, such surge absorber can be likewise provided between the power output terminal RTO1 and reference output terminal RTO1 of the EMI filter 320 to enhance the performance of the power supplying apparatus 300. Furthermore, voltage surge suppressing gas discharge tubes P1, P2 are connected between the two terminals at which the inductor module L212 is coupled to the power input terminal PTI1 and the power output terminal PTO1, and between the two terminals at which the inductor module L212 is coupled to the reference terminal RTI1 and the reference output terminal RTO1, respectively, which have the same function as that of the surge absorber Z1 as described above.

In addition, in the present embodiment, the power supplying apparatus 300 does not require all of the Y capacitors CY213, CY216, CY214 and CY217. Rather, one (any one) of the Y capacitors CY213, CY216, CY214 and CY217 included in the EMI filter 320 is enough to make the power supplying apparatus 300 work normally.

Besides, the inductor module L212 constructed by the common mode inductor as illustrated in FIG. 3A can also eliminate differential mode noises in addition to the common mode noises.

Referring to FIG. 3B, FIG. 3B illustrates a circuit of the power supplying apparatus 300 according to another embodiment. As shown in FIG. 3B, the power supplying apparatus 300 further includes an EMI filter 330 connected between the EMI filter 320 and the rectifier 310. The EMI filter 330 includes an X capacitor C216, Y capacitors CY218, CY215, and the inductor module L211. In addition, the resistors R221, R212 are coupled in the EMI filter 330. The EMI filter 330 includes a power input terminal PTI2, a reference input terminal RTI2, a power output terminal PTO2, and a reference output terminal RTO2. The power output terminal PTO2 and reference output terminal RTO2 are coupled to the power input terminal PTI1 and reference input terminal RTI1, respectively. The Y capacitors CY218, CY215 are connected in series between the power input terminal PTI2 and the reference input terminal RTI2, and the joint between the CY218 and CY215 is connected to the ground terminal GDT. The inductor module L211 is bridged between the power input terminal PTI2, the reference input terminal RTI2, the power output terminal PTO2, and the reference output terminal RTO2. The X capacitor C216 is connected between the power input terminal PTI2 and the reference input terminal RTI2. The resistors R221, R212 are connected in series between the power input terminal PTI2 and the reference input terminal RTI2. In the present embodiment, the DC output power VOUT is produced between the power output terminal PTO2 and the reference output terminal RTO2.

Similar to the inductor module L212 of the EMI filter 320, voltage surge suppressing gas discharge tubes P3, P4 may be connected between the two terminals at which the inductor module L211 is coupled to the power input terminal PTI2 and the power output terminal PTO2, and between the two terminals at which the inductor module L211 is coupled to the reference terminal RTI2 and the reference output terminal RTO2, respectively, which have the same function as that of the P1, P2 described above.

In testing the actual circuit, the Y capacitors CY215, CY216, CY213 of this embodiment can even be removed, the Y capacitor CY218 can be one with small capacitance 4400 pF, and the inductance of the inductor module L211, L212 can be reduced from 3.5 mH, 9 mH to 1.5 mH 7.6 mH, respectively. After making these modifications, the actual circuit can still pass the EMI test.

Specifically, in the present embodiment, each of the EMI filters 320 and 330 needs to include a minimum of one Y capacitor (i.e. the EMI filter 330 only includes one of the Y capacitors CY218, CY215, and the EMI filter 320 only includes one of the Y capacitors CY213, CY216, CY214, CY217) to make the power supplying apparatus 300 work normally.

It is noted that in the exemplary embodiments of FIG. 3A and FIG. 3B, the inductor module L211, L212 implemented as a common mode inductor is for the purposes of illustration only. The inductor module L211, L212 can also be constructed as a differential mode inductor. Therefore, the illustration of FIGS. 3A and 3B is not intended to be used to limit the present invention.

FIG. 3C and FIG. 3D illustrate the EMI test results of the power supplying apparatus 300. Specifically, FIG. 3C illustrates the test result of the L line (i.e. fire line), and FIG. 3D illustrates the test result of the N line (i.e. neutral line) of the power supplying apparatus 300.

Test points T1, T2 and T3 of FIG. 3C represent interfering noises tested at different frequencies. The test frequency corresponding to the test point T1 is 0.1815 Mega Hertz (MHz), the test frequency corresponding to the test point T2 is 23.3708 MHz, and the test frequency corresponding to the test point T3 is 3.3414 MHz. The interfering noises tested at the test points T1, T2 and T3 are 51.20 dB, 31.09 dB, and 32.60 dB, which are smaller than standard values' upper limits 64.43 dB, 60.00 dB, 58.00 dB, respectively. Test points T1 and T2 represent the interfering noises tested at different frequencies. The test frequency corresponding to the test point T1 is 0.6671 MHz, and the test frequency corresponding to the test point T2 is 21.7774 MHz. The interfering noises tested at the test points T1 and T2 are 50.60 dB and 31.60 dB, which are smaller than standard values' upper limits 56.0 dB and 60.00 dB, respectively.

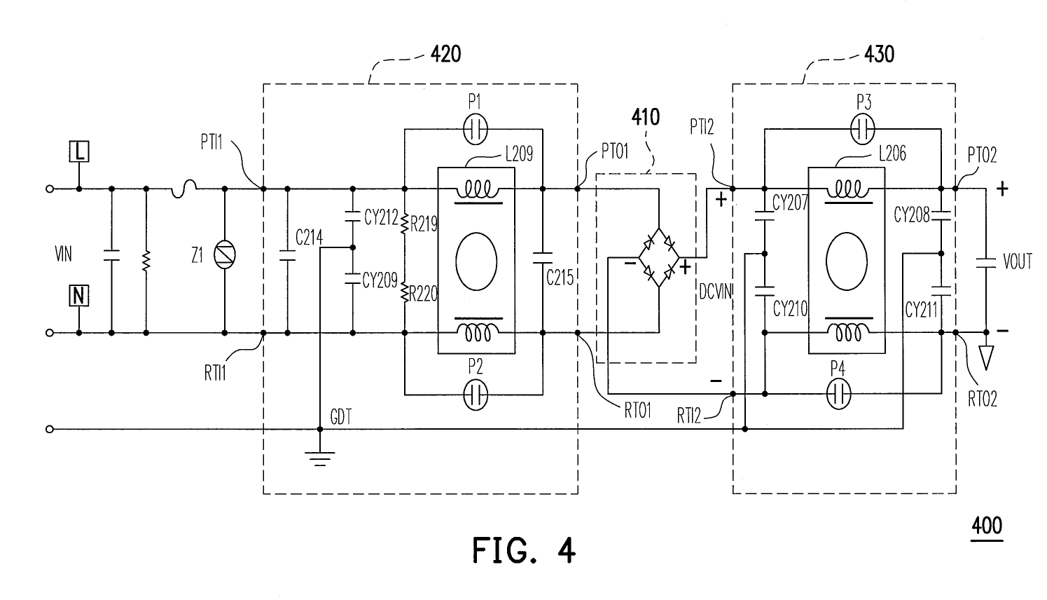

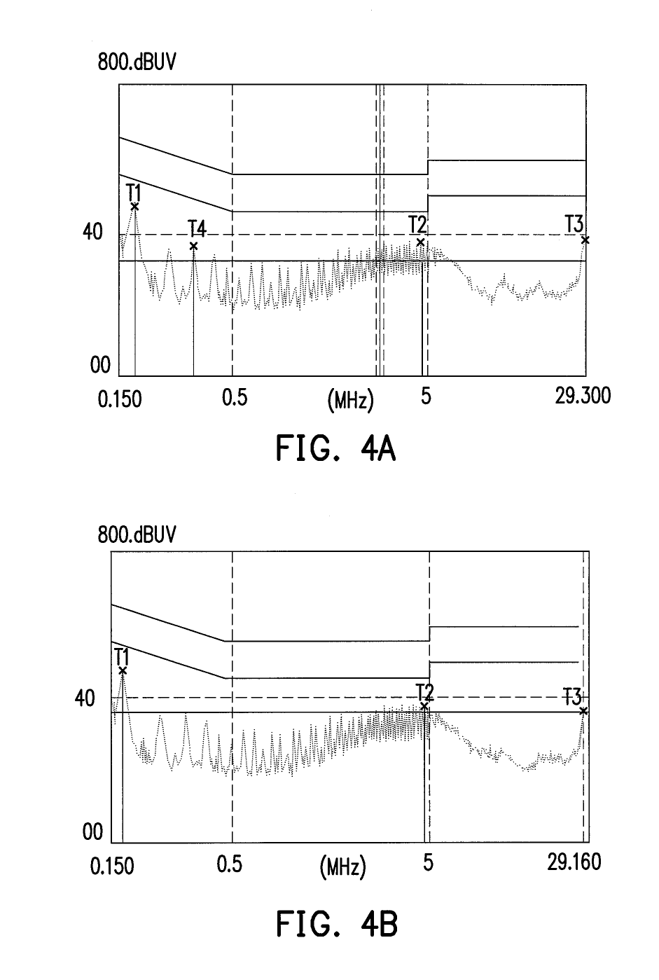

FIG. 4 illustrates a circuit of a power supplying apparatus 400 according to another embodiment of the present invention. Referring to FIG. 4, the power supplying apparatus 400 includes a rectifier 410, and EMI filters 420 and 430. The EMI filter 420 directly receives and filters an AC input power VIN. The EMI filter 420 then transmits the filtered input power to the rectifier 410 for rectification to generate a DC power DCVIN. Finally, the EMI filter 430 receives and filters the DC power DCVIN to generate a DC output power VOUT.

As in the previous embodiment, the EMI filter 420 includes X capacitors C214, C215, Y capacitors CY212, CY209, and an inductor module L209. The EMI filter 420 includes a power input terminal PTI1 and a reference input terminal RTI1. The X capacitor C214 is bridged between the power input terminal PTI1 and the reference input terminal RT11. The Y capacitors CY212 and CY209 are connected in series between the power input terminal PTI1 and the reference input terminal RTI1, and the joint between the Y capacitors CY212 and CY209 is connected to the ground terminal GDT. In addition, the resistors R219 and R220 are connected in series between the power input terminal PTI1 and the reference input terminal RT11. The EMI filter 420 further includes a power output terminal PTO1 and a reference output terminal RTO1. The inductor module L212 is bridged between the power input terminal PTI1, the reference input terminal RTI1, the power output terminal PTO1, and the reference output terminal RTO1. The X capacitor C215 is bridged between the power output terminal PTO1 and the reference output terminal RTO1.

Different from the previous embodiment, the EMI filter 420 receives an AC input power VIN. The rectifier 410 receives and rectifies the input power that has been filtered by the EMI filter 420, to produce a DC power DCVIN. The EMI filter 430 receives and filters the DC power DCVIN. The EMI filter 430 includes Y capacitors CY207, CY210, CY208 and CY211, and an inductor module L206. The EMI filter 430 includes a power input terminal PTI2, a reference input terminal RTI2, a power output terminal PTO2, and a reference output terminal RTO2. The power input terminal PTI2 and the reference input terminal RTI2 receive the DC power DCVIN. The Y capacitors CY207, CY210 are connected in series between the power input terminal PTI2 and the reference input terminal RTI2, and the joint between the Y capacitors CY207, CY210 is connected to the ground terminal GDT. The Y capacitors CY208, CY211 are connected in series between the power output terminal PTO2 and the reference output terminal RTO2, and the joint between the Y capacitors CY208, CY211 is likewise connected to the ground terminal GDT. The inductor module L206 is bridged between the power input terminal PTI2, the reference input terminal RTI2, the power output terminal PTO2, and the reference output terminal RTO2. In addition, a filtered DC output power VOUT is produced between the power output terminal PTO2 and the reference output terminal RTO2.

Likewise, the performance of the power supplying apparatus 400 can be enhanced by a surge absorber bridged between the power input terminal PTI2 and the reference input terminal RTI2 which close to the position that the rectifier 410 outputs the power DC VIN. In addition, voltage surge suppressing gas discharge tubes P1, P2 may be connected between the two terminals at which the inductor module L209 is coupled to the power input terminal PTI1 and the power output terminal PTO1, and between the two terminals at which the inductor module L209 is coupled to the reference terminal RTI1 and the reference output terminal RTO1, respectively. Likewise, voltage surge suppressing gas discharge tubes P3, P4 may be connected between the two terminals at which the inductor module L206 is coupled to the power input terminal PTI2 and the power output terminal PTO2, and between the two terminals at which the inductor module L206 is coupled to the reference terminal RTI2 and the reference output terminal RTO2, respectively.

It is noted that, in the present embodiment, each of the EMI filters 420 and 430 needs to include a minimum of one Y capacitor (i.e. the EMI filter 420 only includes one of the Y capacitors CY212, CY209, and the EMI filter 430 only includes one of the Y capacitors CY207, CY208, CY210, CY211) to make the power supplying apparatus 400 work normally.

FIG. 4A and FIG. 4B illustrate the EMI test results of the power supplying apparatus 400. Specifically, FIG. 4A illustrates the test result of the L line (i.e. fire line), and FIG. 4B illustrates the test result of the AC input power of the N line (i.e. neutral line) of the power supplying apparatus 400.

Test points T1, T2, T3 and T4 of FIG. 4A represent interfering noises tested at different frequencies. The test frequency corresponding to the test point T1 is 0.1735 MHz, the test frequency corresponding to the test point T2 is 4.6400 MHz, the test frequency corresponding to the test point T3 is 29.1610 MHz, and the test frequency corresponding to the test point T4 is 0.3445 MHz. The interfering noises tested at the test points T1, T2, T3 and T4 are 46.20 dB, 38.00 dB, 38.60 dB, and 36.00 dB, which are smaller than standard values' upper limits 64.79 dB, 56.00 dB, 60.00 dB, and 59.09 dB, respectively. Test points T1, T2 and T3 of FIG. 4B represent the interfering noises tested at different frequencies. The test frequency corresponding to the test point T1 is 0.1715 MHz, the test frequency corresponding to the test point T2 is 4.6464 MHz, and the test frequency corresponding to the test point T3 is 28.9527 MHz. The interfering noises tested at the test points T1, T2 and T3 are 46.80 dB, 38.20 dB and 35.40 dB, which are smaller than standard values' upper limits 64.89 dB, 56.00 dB and 60.00 dB, respectively.

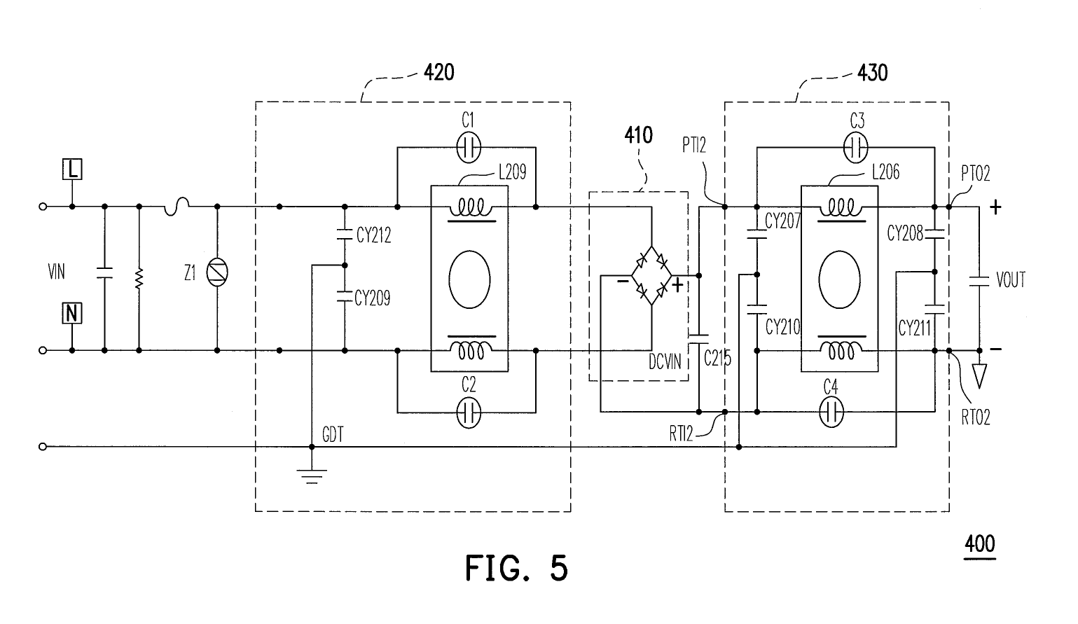

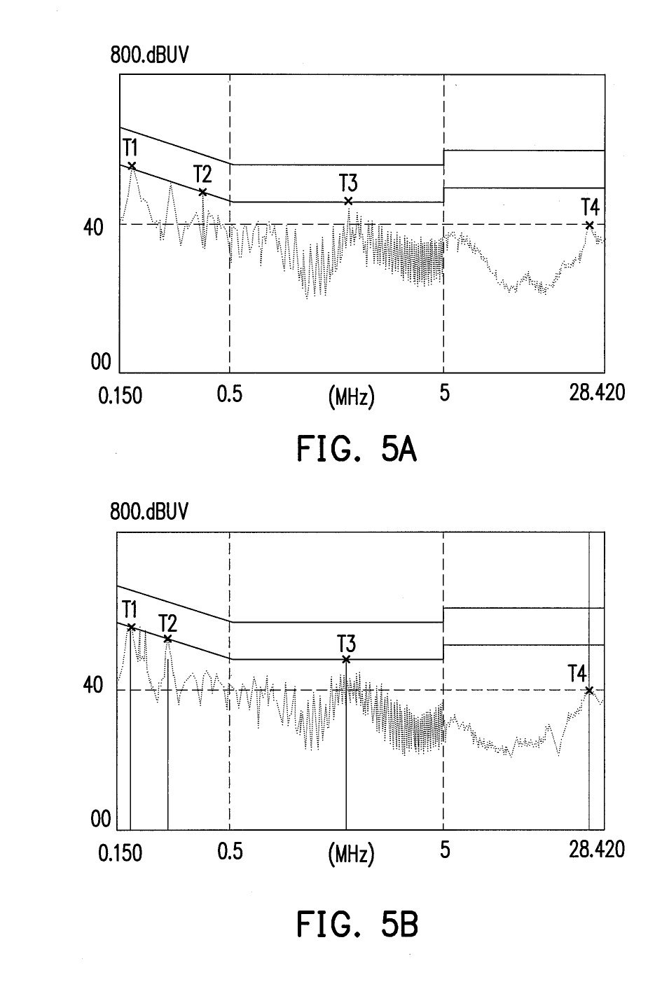

In addition, the circuit architecture of the power supplying apparatus 400 of the embodiment illustrated in FIG. 4 may be modified to further eliminate certain circuit elements to reduce circuit cost. FIG. 5 illustrates a circuit of the power supplying apparatus 400 according to another embodiment. Referring to FIG. 5 in comparison with FIG. 4, the X capacitor C214 and resistors R219, R220 of the EMI filter 420 of FIG. 4 are removed, and the X capacitor C215 of the EMI filter 420 of FIG. 4 is modified to be coupled between the power input terminal PTI2 and the reference input terminal RTI2 of the EMI filter 430 in FIG. 5.

Practical EMI test results of this embodiment are illustrated in FIG. 5A and FIG. 5B. FIG. 5A and FIG. 5B illustrate the EMI test results of the power supplying apparatus 400 of FIG. 5. Specifically, FIG. 5A illustrates the test result of the L line (i.e. fire line) of the power supplying apparatus 400 of FIG. 5, and FIG. 5B illustrates the test result of the AC input power of the N line (i.e. neutral line) of the power supplying apparatus 400 of FIG. 5.

Test points T1, T2, T3 and T4 of FIG. 5A represent interfering noises tested at different frequencies. The test frequency corresponding to the test point T1 is 0.1705 MHz, the test frequency corresponding to the test point T2 is 0.3639 MHz, the test frequency corresponding to the test point T3 is 1.7793 MHz, and the test frequency corresponding to the test point T4 is 24.3881 MHz. The interfering noises tested at the test points T1, T2, T3 and T4 are 55.20 dB, 48.60 dB, 44.00 dB, and 39.00 dB, which are smaller than standard values' upper limits 64.94 dB, 58.64 dB, 56.00 dB, and 60.00 dB, respectively. Test points T1, T2, T3 and T4 of FIG. 5B represent interfering noises tested at different frequencies. The test frequency corresponding to the test point T1 is 0.1730 MHz, the test frequency corresponding to the test point T2 is 0.2585 MHz, the test frequency corresponding to the test point T3 is 1.7729 MHz, and the test frequency corresponding to the test point T4 is 25.3083 MHz. The interfering noises tested at the test points T1, T2, T3 and T4 are 55.40 dB, 49.80 dB, 44.20 dB, and 37.8 dB, which are smaller than standard values' upper limits 64.82 dB, 61.48 dB, 56.00 dB, and 60.00 dB, respectively.

In summary, in the present invention, a part of or all of the EMI filters are moved to the back end of rectifier such that the part of or all of the EMI filters receive and filter the DC power. Under this architecture, the power supplying apparatus has the following the advantages:
1. The EMI filter no longer needs to be connected to the fire and neutral lines of the AC power. In stead, the EMI filter receives the rectified DC power, such that the length of the fire and neutral lines can be effectively reduced.
2. The resistors connected in parallel with the X/Y capacitors in the EMI filter can be eliminated. This not only reduces the number of the circuit elements, but also effectively reduces the current consumption of the power supplying apparatus at zero-load of the power supplying apparatus.
3. Allowing the X/Y capacitors to be replaced with ordinary capacitors not complying with the safety specifications, the AC component thereof is significantly decreased. This allows the capacitance of the X/Y capacitors to be increased and hence. Besides, the inductance of the inductor module in the EMI filter can be reduced to reduce cost. Furthermore, the equivalent DC impedance of the inductor module can be reduced thus reducing power consumption.

In other words, the present solution can significantly reduce the number of the Y capacitors and inductor modules as well as the inductance of the inductor module. In the conventional EMI filter, the inductor module occupies a large space and leads to a high cost. The present solution can effectively reduce the size and cost of the inductor module and hence the layout space of the circuit, such that the size and cost of the power supply can be significantly reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A power supplying apparatus comprising:
a rectifier adapted to receive and rectify an alternating current input power to produce a direct current power;
a first electromagnetic interference filter coupled to the rectifier and having a first power input terminal, a first reference input terminal, a first power output terminal, and a first reference output terminal, wherein the first electromagnetic interference filter is adapted to directly receive the direct current power through the first power input terminal and the first reference input terminal, and filter the direct current power to produce a direct current output power between the first power output terminal and the first reference output terminal, wherein the first electromagnetic interference filter comprises:
a first inductor module bridged between the first power input terminal, the first reference input terminal, the first power output terminal and the first reference output terminal;
a first X capacitor bridged between the first power input terminal and the first reference input terminal; and
a first Y capacitor, wherein one terminal of the first Y capacitor is coupled to one of the first power input terminal, the first power output terminal, the first reference input terminal and the first reference output terminal, and the other terminal of the first Y capacitor is coupled to a ground terminal.

2. The power supplying apparatus according to claim 1, further comprising a second, a third and a fourth Y capacitors, wherein the second, the third and the fourth Y capacitors are commonly connected to the ground terminal, and are coupled to three of the first power input terminal, the first power output terminal, the first reference input terminal and the first reference output terminal that are not coupled to the first Y capacitor.

3. The power supplying apparatus according to claim 1, wherein the first inductor module is a common mode inductor or a differential mode inductor.

4. The power supplying apparatus according to claim 1, further comprising a second electromagnetic interference filter connected between the rectifier and the first electromagnetic interference filter, wherein the second electromagnetic interference filter has a second power input terminal, a second reference input terminal, a second power output terminal and a second reference output terminal, the second power input terminal and the second reference input terminal are coupled to the rectifier, the second power output terminal is coupled to the first power input terminal, and the second reference output terminal is coupled to the first reference input terminal.

5. The power supplying apparatus according to claim 4, wherein the second electromagnetic filter comprises:
a second inductor module bridged between the second power input terminal, the second reference input terminal, the second power output terminal and the second reference output terminal;
a second X capacitor bridged between the second power input terminal and the second reference input terminal; and
a fifth Y capacitor, wherein one terminal of the fifth Y capacitor is coupled to the second power input terminal or the second reference input terminal, and the other terminal of the fifth Y capacitor is coupled to the ground terminal.

6. The power supplying apparatus according to claim 5, wherein the second electromagnetic interference filter further comprises a sixth Y capacitor, and one terminal of the sixth Y capacitor is coupled to one of the second reference input terminal and the second power input terminal that is not coupled to the fifth Y capacitor, and the other terminal of the sixth Y capacitor is coupled to the ground terminal.

7. The power supplying apparatus according to claim 5, wherein the second inductor module is a common mode inductor or a differential mode inductor.

8. The power supplying apparatus according to claim 5, wherein the second electromagnetic interference filter further comprises:
a first gas discharge tube connected between the second power input terminal and the second power output terminal; and
a second gas discharge tube connected between the second reference input terminal and the second reference output terminal.

9. The power supplying apparatus according to claim 5, wherein the second electromagnetic interference filter further comprises:
a first resistor having one terminal coupled to the second power input terminal; and
a second resistor having one terminal coupled to the other terminal of the first resistor, the other terminal of the second resistor coupled to the second reference input terminal.

10. The power supplying apparatus according to claim 1, wherein the first electromagnetic interference filter further comprises:
a first resistor having one terminal coupled to the first power input terminal; and
a second resistor having one terminal coupled to the other terminal of the first resistor, the other terminal of the second resistor coupled to the first reference input terminal.

11. The power supplying apparatus according to claim 1, wherein the first electromagnetic interference filter further comprises:
a first gas discharge tube connected between the first power input terminal and the first power output terminal; and
a second gas discharge tube connected between the first reference input terminal and the first reference output terminal.

12. The power supplying apparatus according to claim 1, further comprising a surge absorber bridged between two input terminals of the rectifier.

13. The power supplying apparatus according to claim 1, wherein the rectifier is a bridge type rectifier.

14. A power supplying apparatus comprising:
a first electromagnetic interference filter having a first power input terminal, a first reference input terminal, a first power output terminal and a first reference output terminal, wherein the first electromagnetic interference filter is adapted to directly receive and filter an alternating current input power, and the first electromagnetic interference filter comprises:
a first inductor module bridged between the first power input terminal, the first reference input terminal, the first power output terminal and the first reference output terminal; and
a first Y capacitor, wherein one terminal of the first Y capacitor is coupled to the first power input terminal or the first reference input terminal, and the other terminal of the first Y capacitor is coupled to a ground terminal;
a rectifier coupled to the first electromagnetic interference filter, wherein the rectifier is adapted to receive and rectify the filtered alternating current power to produce a direct current power; and
a second electromagnetic interference filter having a second power input terminal, a second reference input terminal, a second power output terminal and a second reference output terminal, wherein the second electromagnetic interference filter is coupled to the rectifier and adapted to directly receive and filter the direct current power to produce a direct current output power, and wherein the second electromagnetic interference filter comprises:
a second inductor module bridged between the second power input terminal, the second reference input terminal, the second power output terminal and the second reference output terminal; and
a second Y capacitor, wherein one terminal of the second Y capacitor is coupled to one of the second power input terminal, the second reference input terminal, the second power output terminal and the second reference output terminal, and the other terminal of the second Y capacitor is coupled to the ground terminal; and
a first X capacitor, wherein one terminal of the first X capacitor is coupled to the second power input terminal and the other terminal of the first X capacitor is coupled to the second reference input terminal.

15. The power supplying apparatus according to claim 14, wherein the first electromagnetic interference filter further comprises a third Y capacitor, one terminal of the third Y capacitor is coupled to one of the first reference input terminal and the first power input terminal that is not coupled to the first Y capacitor, and the other terminal of the third Y capacitor is coupled to the ground terminal.

16. The power supplying apparatus according to claim 14, wherein the second electromagnetic interference filter further comprises the fourth, fifth, sixth Y capacitors, and wherein the fourth, fifth, sixth Y capacitors are commonly coupled to the ground terminal and are coupled to three of the second power input terminal, the second reference input terminal, the second power output terminal and the second reference output terminal that are not coupled to the second Y capacitor.

17. The power supplying apparatus according to claim 14, wherein the first electromagnetic interference filter further comprises:
a first gas discharge tube connected between the first power input terminal and the first power output terminal; and
a second gas discharge tube connected between the first reference input terminal and the first reference output terminal.

18. The power supplying apparatus according to claim 14, wherein the second electromagnetic interference filter further comprises:
a third gas discharge tube connected between the second power input terminal and the second power output terminal; and
a fourth gas discharge tube connected between the second reference input terminal and the second reference output terminal.

19. The power supplying apparatus according to claim 14, further comprising a surge absorber bridged between two terminals of the rectifier.

20. The power supplying apparatus according to claim 14, wherein the rectifier is a bridge type rectifier.

21. The power supplying apparatus according to claim 14, wherein the first or the second inductor modules is one of a common mode inductor and a differential mode inductor.
